(19) United States
(12) Patent Application Publication
(10) Pub. No.: US 2009/0100479 A1
(43) Pub. Date: Apr. 16, 2009

(54) Media Online Broadcasting

(76) Inventor: Christopher James Elias, Fort Wayne, IN (US)

Correspondence Address: Christopher James Elias, 1802 Kelleys Landing, Fort Wayne, IN, 46825, US

(21) Appl. No.: 12/023,689

(22) Filed: Jan. 31, 2008

Related U.S. Application Data
(60) Provisional application No. 60/979,129, filed on Oct. 11, 2007.

(51) Int. Cl. H04N 7/173

(52) U.S. Cl. 725/87

(57) ABSTRACT

Media online and/or offline broadcasting software but not limiting to just and/or only media online and/or offline broadcasting software which operation within a multimedia software program but not limiting to just and/or only to multimedia software enabling the access of a variety of multimedia sources but not limiting it to just and/or only multimedia sources to be utilized on a variety of multimedia players and/or anything that can show any form of video and/or any form of text, and/or any form of audio. This software will allow ability to air anything on any device and/or form of audio and/or any form of video, and/or any form of text and allow the customer(s) to utilize this at their convenience.

This application emanates from a previous provisional patent filing; Application number 60979129

### FIELD OF THE INVENTION

The present invention relates to multimedia software programming, but not limiting it to just and/or only multimedia software more specifically, software enabling the access of a variety of multimedia sources, but not limiting it to just and/or only multimedia sources to be utilized on a variety of multimedia players but not limiting it to just and/or only multimedia players, but anything that can show any form of video, and/or any form of text, and/or any form of audio.

### BACKGROUND OF THE INVENTION

This software but not limiting to just and/or only this software will use old and/or existing and/or up-to-date technology and/or possibly newly created technology to send and receive the media and/or payments and/or bills. This would be done by an Internet and/or Intranet site, and/or whatever the client(s) airing the program wants to air it on, and/or since everything is done by satellites these days, it can be broadcasted via satellite and/or sent to the servers, and/or played from servers and sent to the customer(s) through old and/or existing and/or up-to-date technology and/or newly created technology. First time a program is being aired, it will be saved on a server and/or whatever the service provider(s) wants to save the program(s) on for future showings. For future showings, it would be on-demand, being broadcasted via the server(s) and/or whatever the service provider(s) wants to use to air on-demand program(s).

The following outlines forms of programming and and/or program availabilities But not limiting it to any form of programming and/or program availabilities for the current and/or existing and/or new software to manage;

Broadcast Actual Times and On-Demand:

Blackout Games and or Non-Blackout Games
1. NFL
2. NBA
3. MLB
4. NHL
5. PGA Tour
6. Soccer
7. Non U.S. sport events
8. Race Car
9. Boxing
10. and Other Sporting Events not Listed
On-Demand Movies
Movies Playing at the Theater
Concerts Live or On-Demand
Operas Live or On-Demand
Plays Live and On-Demand
News Papers and any Periodicals.
Magazines
Books
Certain Radio stations for free and/or for a fee.
Network and certain satellite stations for free and/or for a fee.
Video games.
Classrooms—Schools Live and On-Demand
Corporate Live and On-Demand:
1. Training
2. Meetings
3. Sponsored Events
Government Live and On-Demand:
1. Alerts—Amber, Local Weather, Emergency,
2. Meetings
3. Sponsored Events
4. Training
Anything that deals with Audio and/or Video motion and/or still and/or Pictures and/or Text can be presented.
Any other form of information and/or entertainment, live and/or on-demand.

The following outlines the process by which the media online broadcasting software and/or any media broadcasting software works:

A customer can:

1. Log into a website, and select what they want to watch and/or hear and/or read and/or play and/or

2. Call the company and/or companies showing what the user(s) want to see and/or hear and/or read and/or play and order the program(s) and/or

3. Select what they want to see and/or hear and/or read and/or play from selecting it from their cell phone, iPod, PDA, Blackberry and/or any other device that can show any form of pictures, and/or motion video and/or still video and/or audio and/or text.
3. Select what they want to see and/or hear from selecting it from their cell phone, iPod, PDA, Blackberry and/or any other device that can show pictures, and/or motion video and/or still video and/or audio.

The customer then pays for it by:
1. Credit card/debit card and/or
2. Any form of legal tender and/or
3. Any legal monetary funds and/or
4. The user can have their order(s) to be billed on their phone bill, cell phone bill, Internet service provider(s) bill, and/or any service and/or utility bill.

The user then can watch and/or read and/or look at and/or hear and/or play the program(s) on their television, computer, cell phone, Palm Pilot, PDA, and/or any other device that can show any form of pictures, and/or motion video and/or still video and/or audio and/or text. The user(s) might have to use any and/or the appropriate multimedia software program to watch, and/or read, and/or look at, and/or hear and/or play the program(s) they ordered.

The software to watch the program(s) would be any but not limiting to just and/or only multimedia software program that they currently use if applicable, and/or they might have to buy and/or install and/or download the appropriate multimedia software but not limiting to just and/or media software to watch and/or look at and/or read, and/or hear and/or play the program(s) they have ordered.

For businesses and schools, they would be issued a secured pin number and password. The person(s) setting up the pictures, and/or motion video and/or still video and/or audio would then give the pin number and password to the people that will be sitting in the program so they can watch and/or read, and/or look at and/or listen to the broadcast. If the government program is a program for the public such as an Amber Alert, these programs will be free to the public, otherwise the public will have to pay to watch, and/or read, and/or look at, and/or listen to the program, and the government and/or schools would pay a fee.

All programs will have the option for customers to watch, and/or read, and/or look at, and/or listen to in closed caption if offered by the company and/or companies they have ordered their program(s) through.

There would be a fee for any program(s) when someone orders any program(s) (exception for schools, government, and businesses. Then the school(s), government, or business would pay a fee for the program, and their subscribers would not have to pay a fee. This will be determined by the service provider(s).)

You can make money by selling sponsorship to movies, operas, theaters, business, government, and/or any other program(s) and/or informative and/or entertainment. The sponsor(s) commercial(s) would be shown before the program, and if it is a program that takes breaks in between it showing, the sponsor(s) commercial(s) would air then as well and/or however the company and/or companies airing the program(s) want the commercial(s) to be shown.

For on-demand programs for schools, government, and businesses, there is a one time setup fee, then a fee per showing for on-demand. This will be at the discretion of the service provider(s). For other customer(s), their may be a one-time setup fee as well, then a fee per program ordering on-demand. There may be a one-time setup fee for live programming as well for everyone. This will be at the discretion of the company and/or companies offering the program(s). Then there will be a fee for each program ordered by the customer(s).

This idea will use old and/or existing and/or up-to-date technology and/or possibly newly created technology to send and receive the media and/or payments and/or bills. This would be done by an Internet and/or Intranet site, and/or whatever the client(s) airing the program wants to air it on, and/or since everything is done by satellites these days, it can be broadcasted via satellite and/or sent to the servers, and/or played from servers and sent to the customer(s) through old and/or existing and/or up-to-date technology and/or newly created technology. First time a program is being aired, it will be saved on a server and/or whatever the service provider(s) wants to save the program(s) on for future showings. For future showings, it would be on-demand, being broadcasted via the server(s) and/or whatever the service provider(s) wants to use to air on-demand program(s).

It is therefore an object of the invention to make any multi-platform and/or any type of platform software which can easily operate payment and activation algorithms on existing and/or new video and/or audio and/or text units

It is another object of the invention to make any software capable of communication with existing and/or new software for the activation of pay per view and/or live formats.

It is another object of the invention to make and/or have any software user friendly for viewing and and/or selecting audio and/or video entertainment and/or text that can show any form of pictures, and/or any form of motion video and/or any form of still video and/or any form of audio, and/or any form of text

It is another object of the invention to make and/or have any software which can work on simultaneous window platforms and/or any platform and/or no platform for the purpose of communication payment and activation hardware controls.

It is another object of the invention to create and/or possibly have software algorithms capable of converting international time tables and currency.

It is another object of the invention to create and/or possibly have software which uses a universal language for the conversion existing language codes.

### SUMMARY OF THE INVENTION

In accordance with the present invention, this allows customer(s) the ability to watch, and/or read, and/or look at, and/or listen and/or play to a wide range of programming not only on their television, but on any device that can show any form of audio and/or any form of video and/or any form of text whenever the customer(s) wants to watch, and/or read, and/or look at, and/or listen, and/or play.

The ability to air anything on any device that can to show and/or play any form of audio, and/or any form of video, and/or any form of text and allow the customer(s) to utilize this at their convenience.

### BRIEF DESCRIPTION OF THE DRAWINGS

Not applicable

### DESCRIPTION OF THE PREFERRED EMBODIMENT

While I have shown and described only a few embodiments in accordance with the present invention, it is understood that the same is not limited thereto but is susceptible of numerous changes and modifications as known to those skilled in the art, and I therefore do not wish to be limited to the details shown and described herein, but intend to cover all such changes and modifications as are encompassed by the scope of the appended claims. Any creation(s), and/or change(s), and/or modification(s), and/or improvement(s) must have written consent from Christopher James Elias and be signed by Christopher James Elias as well as a witness, dated, and legally notarized.

Since other modifications and/or changes varied to fit particular operating requirements and/or environments will be apparent to those skilled in the art, the invention is not considered limited to the example chosen for purposes of disclosure, and covers all changes and/or modifications which do not constitute departures from the true spirit and/or scope of this invention. Any creation(s), and/or change(s), and/or modification(s), and/or improvement(s) must have written consent from Christopher James Elias and be signed by Christopher James Elias as well as a witness, dated, and legally notarized.

The illustrations and examples provided herein are for explanatory purposes and are not intended to limit the scope of the appended claims, as those skilled in the art will make modifications to the invention for particular uses. Any creation(s), and/or change(s), and/or modification(s), and/or improvement(s) must have written consent from Christopher James Elias and be signed by Christopher James Elias as well as a witness, dated, and legally notarized.

What is claimed is:

1. A media online and/or offline broadcasting software program which enables access of a variety of multimedia sources but not limiting to just and/or only multimedia sources to be utilized on a variety of multimedia players but not limiting to just and/or only multimedia players thereof,
said old, and/or existing, and/or new software which enable the access of a variety of multimedia sources, but not limiting to just and/or only multimedia sources to be utilized on a variety of multimedia or text players but not limiting to just and/or only multimedia players and/or text players whereas such software will allow ability to air anything on any device; audio, video, pictures, or text, allowing full time user access.

2. The device of claim 1 wherein the media online broadcasting software can easily operate payment and activation algorithms on existing and/or new video and/or audio and/or text units.

3. The device of claim 1 wherein the media online broadcasting software and/or old software, and/or existing, and/or new broadcasting software is capable of communication with existing and/or new software for the activation of pay per view and/or live formats.

4. The device of claim 1 wherein the media online broadcasting software and/or old broadcasting software, and/or existing broadcasting software, and/or new broadcasting software can work on simultaneous window platforms but not limiting to just and/or only windows platforms for the purpose of communication payment and/or activation hardware controls.

5. The device of claim 1 wherein the media broadcasting software and/or old broadcasting software, and/or existing broadcasting software, and/or new broadcasting software will possibly embody software algorithms capable of converting international time tables and/or currency.

6. The device of claim 1 wherein the media broadcasting software and/or old broadcasting software, and/or existing broadcasting software, and/or new broadcasting software will possibly use a universal language for the conversion existing language codes.
